(19) United States
(12) Patent Application Publication
(10) Pub. No.: US 2012/0314317 A1
(43) Pub. Date: Dec. 13, 2012

(54) Headgear Accessory Attachment System with Adjustable Rearview Mirror

(76) Inventor: Kenneth Wayne ANDERSON, Boerne, TX (US)

(21) Appl. No.: 13/158,399

(22) Filed: Jun. 11, 2011

(51) Int. Cl. G02B 7/182

(52) U.S. Cl. 359/880

(57) ABSTRACT

A system for retaining and adjustably positioning a rearview mirror on an item of headgear. The system includes a flexible, resilient halo band of polymer plastic material removably attachable at each end thereof to the sides of the headgear and extending radially around the front of the headgear across the field of view. A rearview mirror component is slidingly positioned on the halo band and adjustably oriented to provide a rearward view to the wearer of the headgear. The rearview mirror component is a generally rectangular, semi-rigid panel, of polymer plastic material, with an attachment section having an array of parallel slots through which the halo band may be woven, and a reflective section, extending at an angle from the attachment section.

### BACKGROUND OF THE INVENTION

1. Field of the Invention

The present invention relates generally to safety devices for use with vehicles (man-made, such as bicycles and natural, such as horses) capable of transporting one or two individual riders, and to other environments where a visual awareness of the surroundings is desired. The present invention relates more specifically to an accessory attachment system with adjustable rearview mirror component configured to be worn by an individual rider in conjunction with headgear such as a helmet or separately as an item of integrated headgear.

2. Description of the Related Art

Various safety devices have been developed to help protect individuals riding and/or controlling the movement of small one or two occupant vehicles, such as bicycles, motorcycles, snowmobiles, and all terrain vehicles (ATVs). Similar devices have been developed for those riding animals, such as horses. The discussion herein will generally relate to man-made vehicles, although those skilled in the art will recognize that the systems described herein will translate to other environments where headgear might be worn. One safety device that is frequently utilized on such vehicles is a rearview mirror designed to provide a safe and quick view of moving environment to the rear and side of the vehicle and the rider so as to allow the rider to achieve safer movement and control of the vehicle. Conventional devices used for rearward viewing during operation of off-road and on-road vehicles such as described above have many disadvantages. The most common manner of viewing to the rear of a moving vehicle involves the operator simply turning his or her head around to see what is behind and/or to the side. This method of viewing to the rear and the side causes two significant problems. The first involves the total loss of view in the direction of travel. The second involves a reduction in the control that the operator has over the vehicle while the operator is in a contorted body position on the vehicle.

A device commonly used for viewing to the side and/or rear in situations such as described above comprises a permanently or removably mounted mirror positioned on the vehicle or body. Most permanently attached mirrors must be custom mounted using bolts or screws that require drilling holes into the frame or body of the vehicle, which in turn decreases the value of the vehicle and often leads to more rapid structural deterioration. Vehicle mounted mirrors (whether permanent or removable) also often alter the vehicle's exterior lines to a point where a standard protective cover for the vehicle no longer fits or to a point where the aerodynamics of the vehicle may be compromised. In addition, the use of a mirror attached to the frame structure or body of the vehicle often provides only a blurred view of the environment during vehicle operation as vibrations caused by rough terrain or other moving mechanical components of the vehicle compromise the clarity of the view within the mirror. Such vibrations and impacts may also result in damage to the mirror to the point it is no longer functional.

Further efforts have been made to provide rearview mirror devices for small on-road and off-road vehicles that may be positioned on the hands or arms of the operator of the vehicle. Hand mirrors may be strapped to the back of the users hand so as to allow positioning of the mirror by raising the hand and orienting the mirror appropriately. To use these hand mirrors, the operator must typically raise their hand off of the handlebars or other control mechanisms of the vehicle during vehicle operation, a process which greatly compromises the safety associated with optimal control of the vehicle.

Efforts have also been made to attach small mirrors to helmets, helmet visors, or other accessories that an individual operating a small vehicle might wear. While these types of rearview mirror devices reduce the effects of vehicle vibration on the clarity of view, all suffer from additional problems so as to make their use less than complete solutions. The smaller the mirror is, the closer it must be positioned to the user's eye to afford a wide angle rear view. Any mirror close enough to a bicycle rider's eye (for example) to give a broad rear view poses a risk of eye injury in a bicycle accident. In addition, any large or heavy mirror may react to jolts or vibrations on the rider themselves so as to fall out of adjustment and lose focus for a clear and properly oriented rear view.

Nonetheless, the use of a rearview mirror attached to a rider's helmet appears to provide the best general solution for the overall safety problem. The difficulty with existing efforts to incorporate mirrors onto helmets involves the complexity and bulkiness with which the mounting mechanisms must be configured in order to prevent the problems described above. The preference would of course be to have a larger mirror surface to view such that the mirror surface need not be in very close proximity to the eyes of the user. Large mirrors, however, tend to be heavier and therefore require heavier and more complex mounting structures in order to maintain them in place. Typical ball and socket joint structures for placing and positioning mirrors on helmets fail when the size of the mirror becomes too large or the ball and socket joints loosen.

It would therefore be desirable to have a system for mounting safety accessories such as a rearview mirror to the helmet of the rider/operator of a small on-road or off-road vehicle that provides a wide angle field of view and a rugged but inexpensive mechanism for variably positioning the mirror and other safety accessories. It would be desirable if such an accessory attachment system could be incorporated onto existing helmet designs having a variety of sizes and shapes. It would be desirable to allow for the retrofit of such a system to an existing helmet or to incorporate the system into an original equipment manufactured design. It would also be desirable if such a rearview mirror system could be incorporated into a novel item of headgear not necessarily associated with a helmet structure.

### SUMMARY OF THE INVENTION

Accordingly, it is a primary objective of the present invention to facilitate a rearward view of the surrounding, moving environment for the operator of a bicycle, a snowmobile, an ATV, a motorcycle, or similar one or two occupant vehicle.

It is a further objective of the present invention to provide an improved means for securing a rearward view for the operator of an on-road or off-road vehicle, a means that may be positioned on a variety of existing forms of protective headgear worn by operators of such vehicles.

It is a further objective of the present invention to provide an improved means for securing a rearward view for an individual within any environment where an item of headgear might be worn and activities surrounding the individual must be visually monitored.

The objectives of the present invention are fulfilled by providing a system for retaining and adjustably positioning a rearview mirror on a helmet or other item of headgear. The system includes a flexible, resilient halo band of clear polymer plastic material removably attachable at each end thereof to the sides of the helmet and extending radially around the front of the helmet across the field of view. A rearview mirror component is slidingly positioned on the halo band and adjustably oriented to provide a rearward view to the wearer of the helmet. The rearview mirror component may preferably be a generally rectangular, semi-rigid panel, of polymer plastic material, with an attachment section having an array of parallel slots through which the halo band may be woven, and a reflective section, extending at an angle from the attachment section.

The system may include components that fasten to the operator's helmet using hook and loop fastener surfaces with an adhesive backing. This allows the system to be removed and reinstalled any time the operator stores his or her helmet, or transports their helmet in a protective bag. This system also allows the operator to take advantage of a safe and quick view towards the side or rear by providing: no hand movements required which leaves the operator in control of the vehicle with both hands on the handlebars; a quick blind spot free view on both sides of the operator with no head or body movements needed; and only a very slight eye movement similar to the glance needed to look at a speedometer while driving a car. The system is fully adjustable with three axes of rotation incorporated into each mirror.

According to one embodiment of the invention, a mirror and halo track attachment for an existing bicycle helmet is provided where the helmet may have a removable visor. The invention attachment has holes which allow retrofit attachment to the helmet between the visor and the helmet. The mirror weaves onto the halo track which takes on a hoop shape when attached to a bicycle helmet. The mirror travels on the length of the hoop (typically 16 inches) to place the mirror a sufficient distance from the bicycle rider to use to provide a rear view. The mirror travels on the curve of the hoop to adjust the angle of the mirror. The bicycle rider may also easily adjust a third axis, because the mirror is rotatable in its position on the halo track.

Alternate embodiments provide non-helmet type items of headgear that incorporate the same halo track and adjustable mirror elements for use in a variety of visual environments.

### BRIEF DESCRIPTION OF THE DRAWINGS

Reference is now made to the following description taken in conjunction with the accompanying drawings, wherein like reference numbers represent like parts, in which:

FIG. 1 is a perspective view of a typical bicycle helmet implementing the halo band accessory attachment system and adjustable rearview mirror of the present invention.

FIG. 2 is a view from the helmet wearer's perspective of the halo band accessory attachment system of the present invention shown with the adjustable rearview mirror component attached in the orientation of FIG. 1.

FIG. 3 is an elevational view of the adjustable mirror component of the system of the present invention shown removed from the halo band component.

FIG. 4 is a top view of the adjustable mirror component of the system of the present invention, again shown removed from the halo band component of the system.

FIG. 5 is a rear elevational view of a typical bicycle helmet implementing the halo band accessory attachment system of the present invention showing the placement and orientation of the adjustable mirror component of the system.

FIG. 6 is a view from the helmet wearer's perspective of the halo band accessory attachment system of the present invention shown with two adjustable rearview mirror components attached in opposite orientations on the left and right side of the system.

FIGS. 7A & 7B are elevational views of two alternate embodiments of the adjustable mirror component of the system of the present invention, each shown removed from the halo band component.

FIGS. 8A-8E are elevational views of further alternate embodiments of the adjustable mirror component of the system of the present invention, each shown removed from the halo band component.

FIGS. 9A-9D are side elevational views of an alternate embodiment of the halo band system of the present invention with eye glare guard, the halo band component integrated on a headband, a visor, a hat, and on a cap.

FIGS. 10A & 10B are side elevational views of two further alternate embodiments of the halo band component of the system of the present invention shown integrated on a cap.

### DETAILED DESCRIPTION OF THE PREFERRED EMBODIMENTS

As described above, the present invention is intended to be used with a variety of bicycle helmet designs as well as a variety of similar protective headgear products where the user might benefit from the attachment of accessories such as a rearview mirror. The system may be implemented on other types of non-protective headgear as well. The detailed descriptions that follow are generally directed to a bicycle helmet and the use and attachment of the system of the present invention to such helmets. This description, however, is not intended to be limiting of the potential applications for the system of the present invention, but instead should be read as representative of the manner in which the system may be implemented with a variety of different types of protective and non-protective headgear.

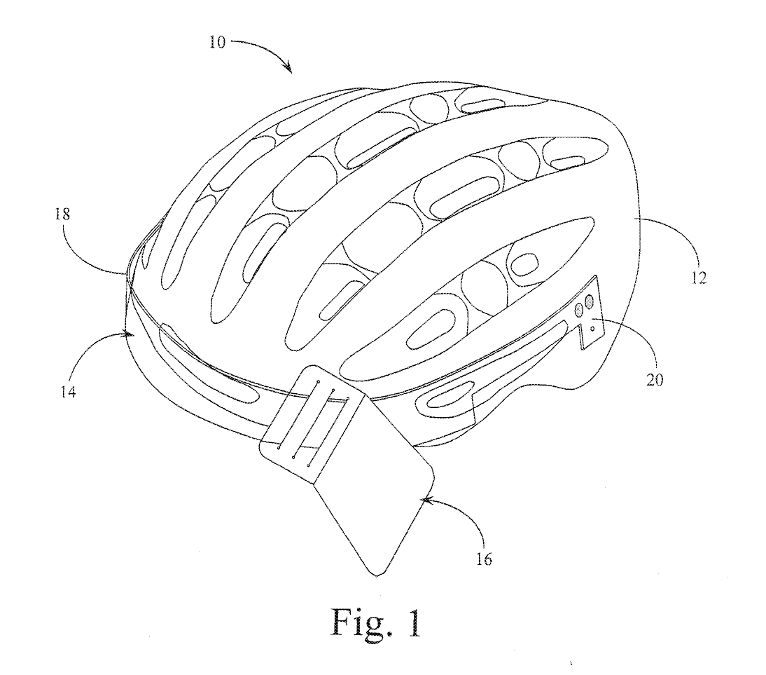

Reference is made first to FIG. 1 which is a perspective view of the bicycle helmet accessory attachment system of the present invention as it may be configured in conjunction with a typical (U.S. region) bicycle helmet. Bicycle helmet system 10 is shown to essentially include helmet shell 12 and halo band accessory system 14. Halo band accessory system 14 is attached to helmet shell 12 in a manner described in more detail below, but generally is positioned from side to side, bent or curved, preferably with a residual clamping force, across the front of the helmet so as to allow the proper placement and positioning of adjustable mirror component 16. Adjustable mirror component 16 is fitted to flexible band 18 which itself is attached to helmet shell 12 at two points on each end of flexible band 18. As shown in FIG. 1, attachment end plate (left side) 20 is shown as a first attachment point to helmet shell 12 while a corresponding end plate (right side), not shown, is used to secure the second end of flexible band 18.

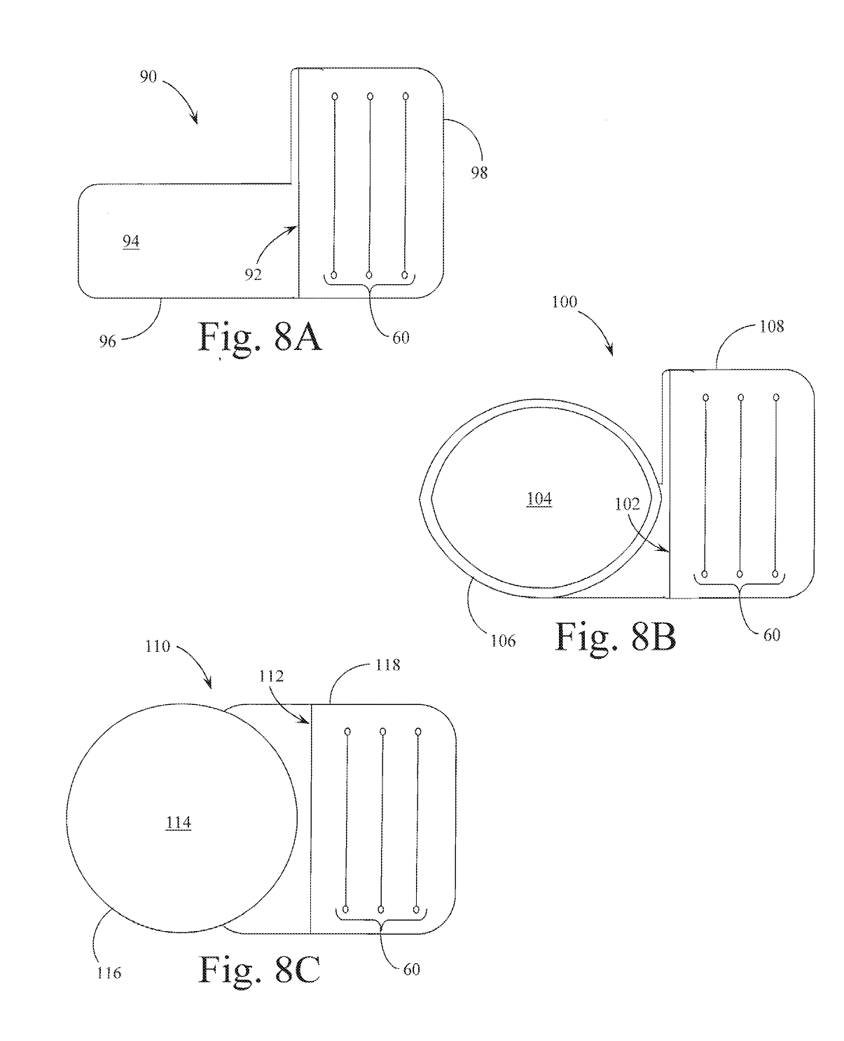

In the manner of the system configuration shown in FIG. 1, adjustable mirror 16 may be variably positioned along flexible band 18, as may be required by the user, to provide the best view towards the side and rear while riding a bicycle. Adjustable mirror 16 slides, in a manner described in more detail below, along flexible band 18 from a first point on the right side of the band all of the way around and across the front to a point on the left side of the band. In this manner it can be seen that adjustable mirror 16 may be positioned and placed on either side of the helmet depending upon the riding conditions that the user is confronted with (such as traffic on the right or left) and further depending on the user's preference. The preferred embodiment placement of adjustable mirror 16 for traffic flow (for example, in the United States and many other countries) would be on the left hand side of helmet shell 12 as shown in FIG. 1. Some modification of the structure of adjustable mirror 16 may be necessary if placement on the right hand side of flexible band 18 is desired. See also the discussion following with respect to FIG. 6 for variations on reversing mirror orientation and doubling mirror placement. It should be clear, however, that the appropriate configuration either on the right or left side of the bicycle helmet can easily be implemented with the structures of the present invention.

FIG. 1 also discloses that the preferred material from which flexible band 18 is made is a clear, flexible, durable sheet of plastic or polymer composition. The polymer material composition sheet should be sufficiently thick and resilient as to maintain a clamping spring force within the halo band once it is placed on and attached at each of its end points to the helmet shell 12. Preference is for a clear polymer sheet so as to allow for additional visual access to the mirror surface as described in more detail below, although some embodiments may incorporate an opaque or partially opaque band to facilitate an eye shading function for the halo band component. The adjustable mirror is preferably a semi rigid sheet of material, bendable at one point (again described in more detail below) and coated on one or both sides with a layer of reflective material. A polycarbonate Lexan® material may best serve as the mirror substrate (backing) while a polyacrylic material may best serve as the reflective surface element. Variations on these composition materials are anticipated.

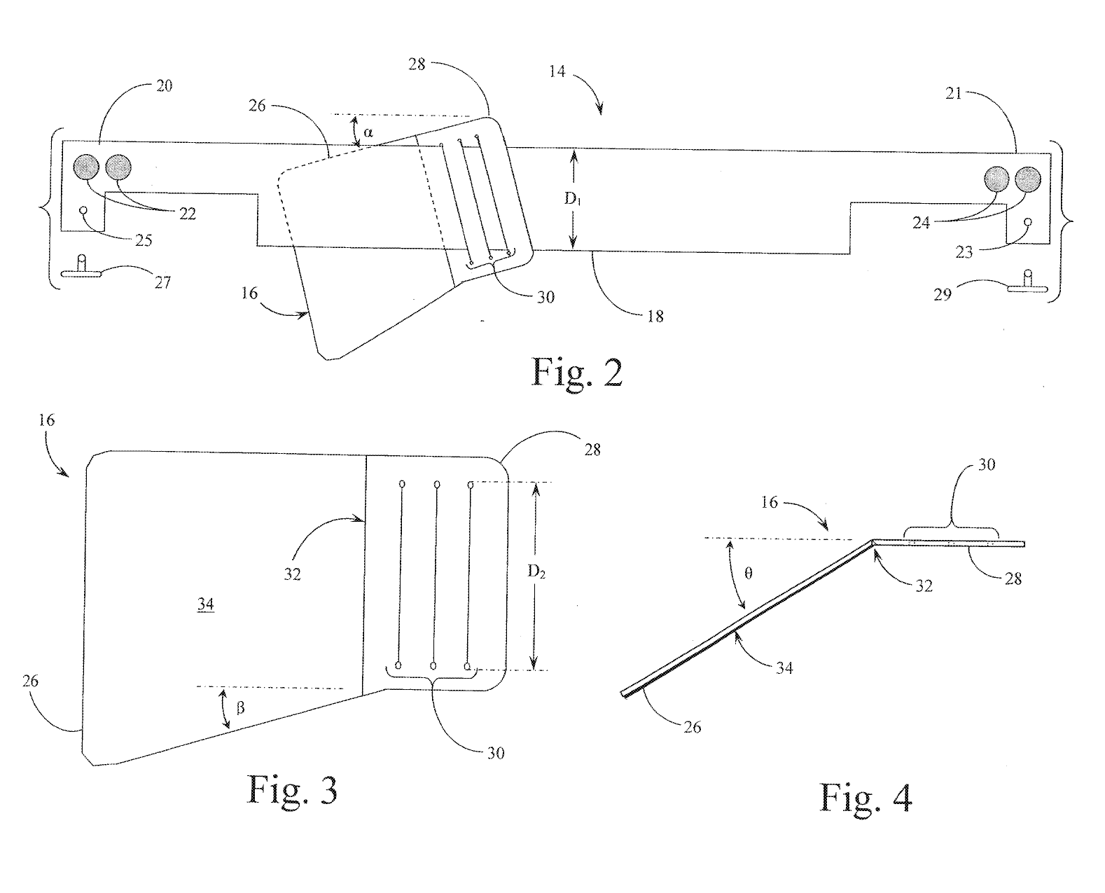

Reference is next made to FIG. 2 for a detailed description of the halo band accessory system 14 of the present invention shown detached from the helmet shell disclosed in FIG. 1. FIG. 2 is a forward looking plan view (that is, a view from the wearer's perspective) of halo band accessory system 14 shown with adjustable mirror component 16 incorporated in a position similar to that shown in FIG. 1. Flexible halo band 18 is shown laid flat (i.e., detached from the helmet); a configuration that the resiliency of the material might preferably resist when detached. Halo band accessory system 14 is shown to be comprised of flexible band 18 having a width of and a length (not shown) commensurate with the desired adjustability of the mirror. In other words, although the width of the flexible band 18 might be consistent, it is preferable to provide bands of varying lengths to accommodate different helmet sizes and different desired mirror adjustments.

Each end of flexible band 18 is configured with an attachment end plate. Left side attachment end plate 20 is shown on one end of flexible band 18 with right side attachment end plate 21 positioned on the opposite end of flexible band 18. Associated with each of the attachment end plates 20 and 21 are a variety of attachment components. In FIG. 2, hook and loop attachment pads 22 are shown with left side attachment end plate 20, while hook and loop attachment pads 24 are shown associated with right side attachment end plate 21. Attachment post aperture 25 is shown configured on left side attachment end plate 20 and attachment post aperture 23 is shown configured on right side attachment end plate 21.

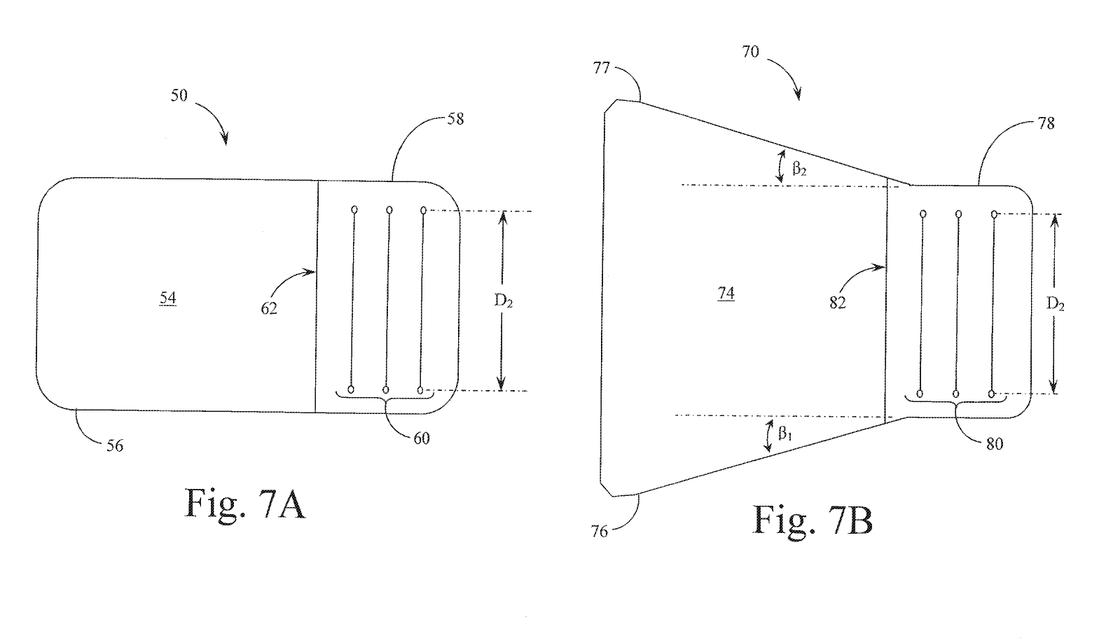

Hook and loop attachment pads 22 and 24 are preferably matched pairs (one helmet, one band) with corresponding pads positioned on the helmet shell of the bicycle helmet. Referring again to FIG. 1 (as well as FIG. 5), one side of the pair of hook and loop pads may be adhesively attached to the helmet shell, while the corresponding side of the hook and loop pad pair is fixed to the inside surface of flexible halo band 18. In this manner, the hook and loop attachment pads are used to secure each end of the flexible halo band 18 to the helmet shell as shown in FIG. 1.

An alternate means of attaching flexible halo band 18 to the helmet shell may utilize attachment post apertures 23 and 25. These apertures, positioned in attachment end plates 20 and 21, align with and receive attachment posts 27 and 29 that would be fixed to the sides of the helmet shell of the bicycle helmet. Such attachment posts are known in the art and are often utilized to attach visors to helmet shells. The configuration of attachment post apertures 23 and 25 in the present invention is such as to allow use of existing visors in concert with the halo band accessory system of the present invention or to allow use of the halo band accessory system without the use of a visor. In general, therefore, attachment end plates 20 and 21 are configured with a variety of attachment mechanisms that permit attachment of the halo band accessory system 14 to a wide variety of helmet shell configurations.

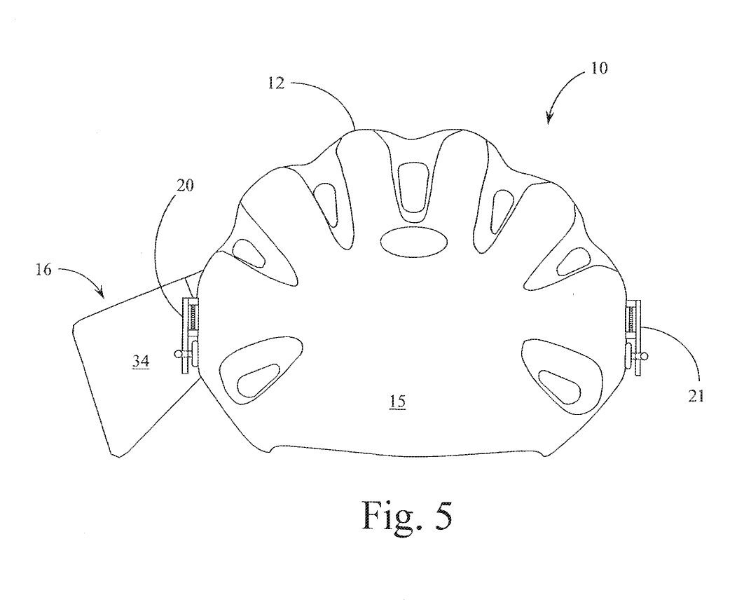

Also shown in FIG. 2 is the manner in which adjustable mirror 16 is positioned on and movable with respect to flexible halo band 18. An array of attachment slots 30 (three in the preferred embodiment) are configured through adjustable mirror attachment section 28. Extending from mirror attachment section 28 is visible mirror extension section 26. This structure of adjustable mirror 16 is described in more detail below with respect to FIG. 3.

Adjustable mirror 16 may be positioned and placed on flexible halo band 18 by sliding halo band 18 through each of attachment slots 30 as shown. The friction between the surfaces of adjustment mirror attachment section 28 (between attachment slots 30) and the surface of flexible halo band 18 is sufficient to allow for the adjustable placement of mirror 16 on the flexible band. The primary adjustments shown in FIG. 2 include adjustable mirror angle α which results from a difference between the width of attachment slots 30 and the flexible halo band width. An additional adjustment is, of course, provided by the side to side movement that may be made with adjustable mirror 16 along the length of flexible band 18.

Reference is next made to FIG. 3 for a detailed description of the structure of adjustable mirror 16 of the present invention. Adjustable mirror 16 may preferably be configured as shown in FIG. 3 as a generally rectangular sheet of semi rigid material having a lower extension that provides an increased viewing surface for the user. Adjustable mirror 16 is generally comprised of visible mirror extension section 26 and adjustable mirror attachment section 28. As described above, attachment section 28 is configured with attachment slots 30 having a slot width as shown. Mirror extension section 26 is associated with and connected to attachment section 28 at bendable joint 32. All or a portion of mirror extension section 26 is covered with mirror surface 34. The non-rectangular lower extension of mirror extension section 26 is preferably configured with a mirror drop angle β as shown. This angle provides a compromise between offering a larger mirror surface 34 visible to the user and the non-obstruction of the forward view of the user. Mirror drop angle β (preferably 0° to 45°) in conjunction with adjustable mirror angle α (also preferably 0° to 45°) shown in FIG. 2 together provide a variable amount of mirror surface 34 visible to the user according to the user's preferences.

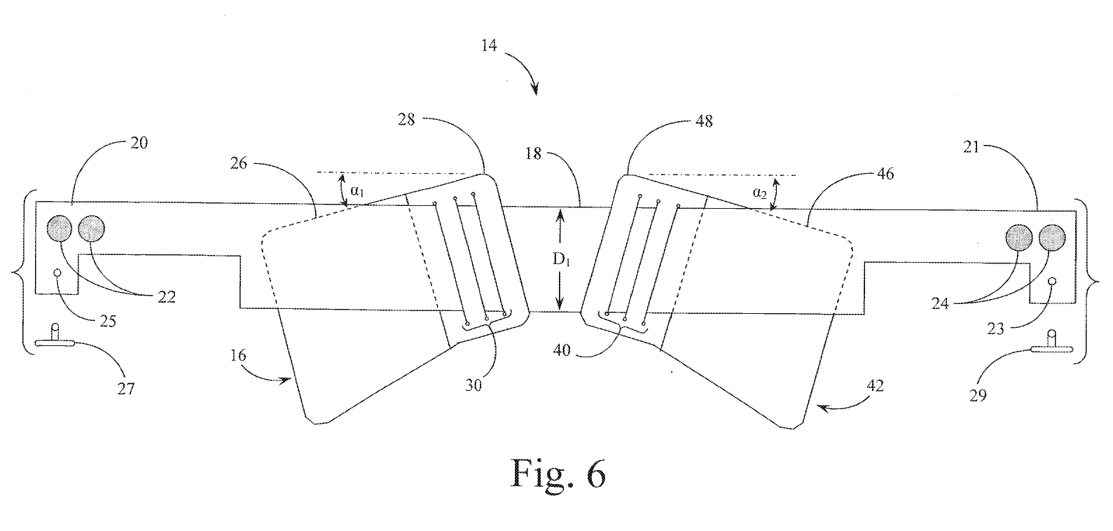

FIG. 4 is a top plan view of the adjustable mirror component 16 of the present invention showing the manner in which visible mirror extension section 26 is bendably connected to adjustable mirror attachment section 28. The bend at bendable joint 32 provides a mirror viewing angle θ (preferably 0° to 45°) as shown. Bendable joint 32 may preferably be a re-positionable joint such as may be provided by any number of plastic substrates (polycarbonate, for example) forming the material from which adjustable mirror 16 is constructed. Such plastic substrates forming the basis for the construction of adjustable mirror 16 may provide a bendable joint 32 that has a relatively long lifetime of minor adjustments back and forth changing the viewing angle θ. Alternate embodiments may utilize a frictional hinge mechanism in place of bendable joint 32 to provide a longer lifetime of more significant adjustments to the viewing angle. In general, a single user would likely set the viewing angle with a manual adjustment of bendable joint 32 and therefore retain that viewing angle through repeated use.

Reference is next made to FIG. 5 which is a rear elevational view of the bicycle helmet system 10 of the present invention as implemented in conjunction with helmet shell 12. In this view, the back 15 of helmet shell 12 is shown with only a small portion of the flexible halo band visible on either side. In this case, right side attachment end plate 21 and left side attachment end plate 20 are shown on either side of helmet shell 12, being attached thereto through the use of hook and loop attachment pads as described above. Also in the view of FIG. 5 may be seen the larger portion of adjustable mirror 16 that is generally visible from the rear of the user (and therefore visible to the user towards the rear). Adjustable mirror 16 is shown positioned at the angles and in the orientation described above, presenting mirrored surface 34 to the user to view the area behind the user and angled to present that same view to the eye of the user wearing the helmet. In the view of FIG. 5 it can be seen how a major portion of mirror surface 34 and of visible mirror extension section 26 can be seen and used for rearview mirror purposes.

The orientation shown in FIG. 5 shows the best view of traffic approaching from behind and to the side of the user wearing the helmet oriented in a forward looking direction. Simple movement of the user's eyes to the side and up to view the rearview mirror surface provides the best available view of traffic approaching from behind to the left hand side. Again, as indicated above, re-orientation of the adjustable mirror 16 may provide for alternate views of traffic approaching from the rear. In addition, side to side movement of the users head will re-orient the view from side to side to the rear of the user in a manner that may be quickly accomplished without jeopardizing the forward view of the user.

Reference is next made to FIG. 6 for a brief description of an alternate preferred embodiment of the halo band accessory system 14 as shown detached from the helmet shell with two adjustable mirror components 16 and 42. These two mirror components 16 and 42 are incorporated at alternate left and right positions similar to that shown in FIG. 1 (the left hand side in the case of mirror component 16) and in a mirrored fashion on the right hand side of flexible halo band 18 in the case of mirror component 42. As indicated above, it is anticipated that mirror component 16 may be constructed to be reversible so as to be alternately positioned on the opposing side of halo band 18, or to be duplicated with symmetrical geometry and presented in matched pairs on each side of halo band 18 as shown in FIG. 6.

In the preferred embodiment of the present invention, this double mirror configuration shown in FIG. 6 would comprise two adjustable mirror components 16 and 42 constructed of the same base material but with mirror surfaces on opposite faces of the base material. The preference for this type of construction would eliminate the presence of a mirrored surface on the outward face of either mirror component. Otherwise, the adjustable aspects of mirror component 42 are identical to adjustable aspects of mirror component 16. Mirror component 42 shown in FIG. 6 includes the same or similar mirror attachment section 48 having an array of attachment slots 40 as shown. Once again, the friction between the surfaces of the adjustment mirror attachment section 48 (between attachment slots 40) and the surface of flexible halo band 18 is sufficient to allow for the adjustable placement of mirror 42 on the flexible band. Adjustable mirror 42 is generally comprised of visible mirror extension 46 and adjustable mirror attachment section 48. The adjustment of mirror 42 may be accomplished by sliding the mirror along the length of halo band 18 and by appropriate tilting of the mirror component through angle similar to the manner in which the corresponding adjustable mirror 16 may be tilted through angle. The user may, of course, adjust the two separate mirror components independently to provide for customized viewing angles from each.

Also shown in FIG. 6 are examples of post attachment components 27 and 29 that may be required with helmet systems that do not already incorporate such attachment components for visors or the like. Post attachment components 27 and 29 may, in the preferred embodiment, be rigid plastic posts extending from plates having an adhesive face that allows for their permanent or semi-permanent mounting on the external shell of the helmet. The halo band of the present invention may then be attached using attachment post apertures 23 and 25 as described above, to these now permanent post attachment components 27 and 29 positioned in an appropriate manner on the sides of the helmet.

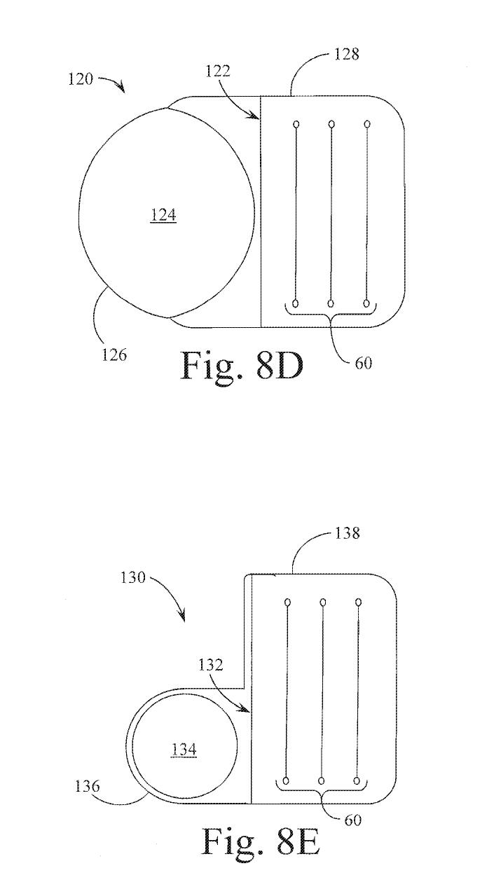

Reference is next made to FIGS. 7A & 7B for detailed descriptions of alternate embodiments of the mirror component of the present invention. FIG. 7A shows adjustable mirror 50 as a first geometrically alternate embodiment for the mirror component. Adjustable mirror 50 may preferably be configured as shown in FIG. 7A as a more basic rectangular sheet of semi-rigid material without the lower mirror extension provided for in the embodiment shown in FIG. 3. Adjustable mirror 50 is generally comprised of mirror extension section 56 and adjustable mirror attachment section 58. As described above, attachment section 58 is configured with attachment slots 60 having a slot width as shown. Mirror extension section 56 is associated with and connected to attachment section 58 at bendable joint 62. All or a portion of mirror extension section 56 is covered with mirror surface 54.

FIG. 7B modifies the embodiment shown and described above with regard to FIG. 3 by providing for an expanded non-rectangular upper and lower wing extension of the mirror section. In FIG. 7B, non-rectangular lower extension section 76 is preferably configured with a mirror drop angle as shown. In a similar fashion, non-rectangular upper extension section 77 is preferably configured with a mirror rise angle as shown. These angles provide an increased mirror surface 74 visible to the user and yet still maintain a generally non-obstructed forward view to the user. Preferred angles to the embodiment shown in FIG. 7B are similar to those described above in conjunction with the embodiment represented in FIG. 3.

Adjustable mirror 70 as shown in FIG. 7B is generally comprised of a visible mirror component made up of lower extension section 76 and upper extension section 77 attached to adjustable mirror attachment section 78. As described above, attachment section 78 is configured with attachment slots 80 having a slot width as shown. Mirror extension sections 76 and 77 are associated with and connected to attachment section 78 at bendable joint 82. All or a portion of mirror extension sections 76 and 77 may be covered with mirror surface 74.

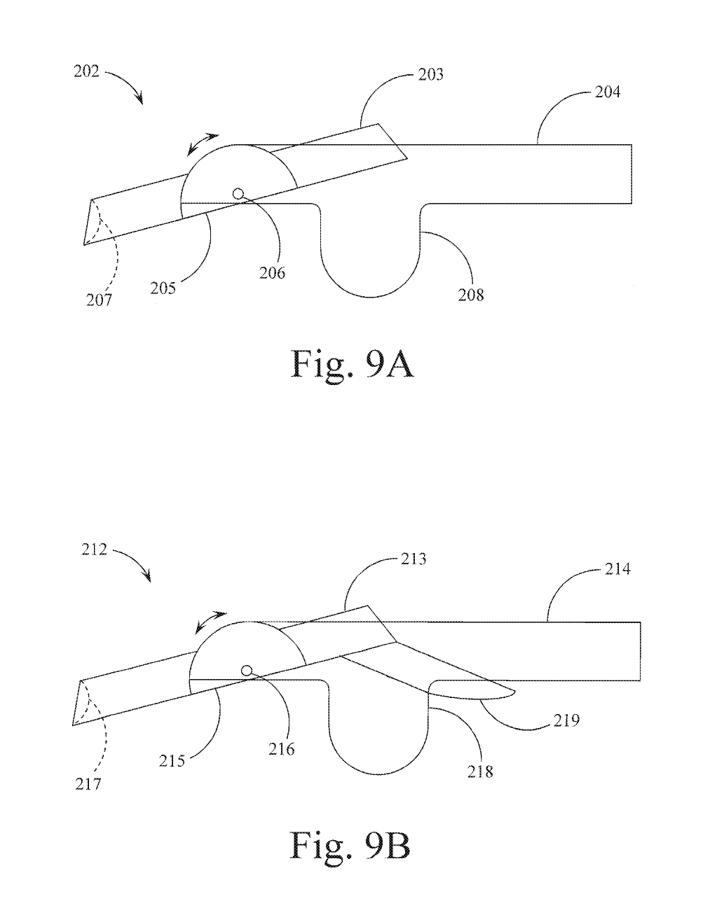

Reference is next made to FIGS. 8A-8E for five further alternate embodiments of the geometric construction of the mirror component of the system of the present invention. In FIG. 8A, adjustable mirror 90 provides a much smaller mirror surface 94 positioned on mirror extension section 96 while maintaining the same sized mirror attachment section 98 connected at bendable joint 92. FIG. 8B provides adjustable mirror 100 incorporating an oblong shaped mirror extension section 106 having mirror surface 104 providing a more customized rearview image to the user. Mirror extension section 106 is associated with and connected to attachment section 108 at bendable joint 102. The embodiment shown in FIG. 8B provides an example where mirror extension section 106 may be made from a substrate material different from the material of mirror surface 104. In this example, mirror surface 104 may be of a harder acrylic material that is set in a recess formed in the softer polycarbonate material of mirror extension section 106.

FIGS. 8C-8E represent further circular or oblong mirror components that address alternate preferences for the user and the user's view. In FIG. 8C, adjustable mirror 110 provides a larger circular mirror surface 114 positioned on mirror extension section 116 while maintaining the same sized mirror attachment section 118 connected at bendable joint 112. In FIG. 8D, adjustable mirror 120 provides a smaller and orthogonally oriented oblong shaped mirror surface 124 positioned on mirror extension section 126, while again maintaining the same sized mirror attachment section 128 connected at bendable joint 122. This orthogonal orientation may be preferable where a greater vertical field of view (such as in mountainous terrain) is desired. Finally, in FIG. 8E, adjustable mirror 130 provides a very small mirror surface 134 positioned on mirror extension section 136, again while maintaining the same sized mirror attachment section 138 connected at bendable joint 132. Various advantages and disadvantages to each of the configurations shown in FIGS. 8A-8E are anticipated. The presentation of these alternate embodiments is intended to be representative of modifications to the mirror component that can be made to reflect specific environments within which the rearview mirror is utilized. In some instances, a very narrow and specific rearview image may be preferred, such as that shown in FIG. 8E which provides for greater forward visibility around the smaller mirror component. Some driving conditions may make the embodiment shown in FIG. 8D preferable which provides an orthogonal orientation to the oblong mirror component shown in FIG. 8B. It will be recognized that an individual user may choose to retain a number of different mirror component embodiments in conjunction with a single halo band system insofar as the mirror components may be removed from and replaced on the halo band as needed. In addition, a primary mirror of a first geometric structure might be paired with a secondary mirror of a distinct geometric structure.

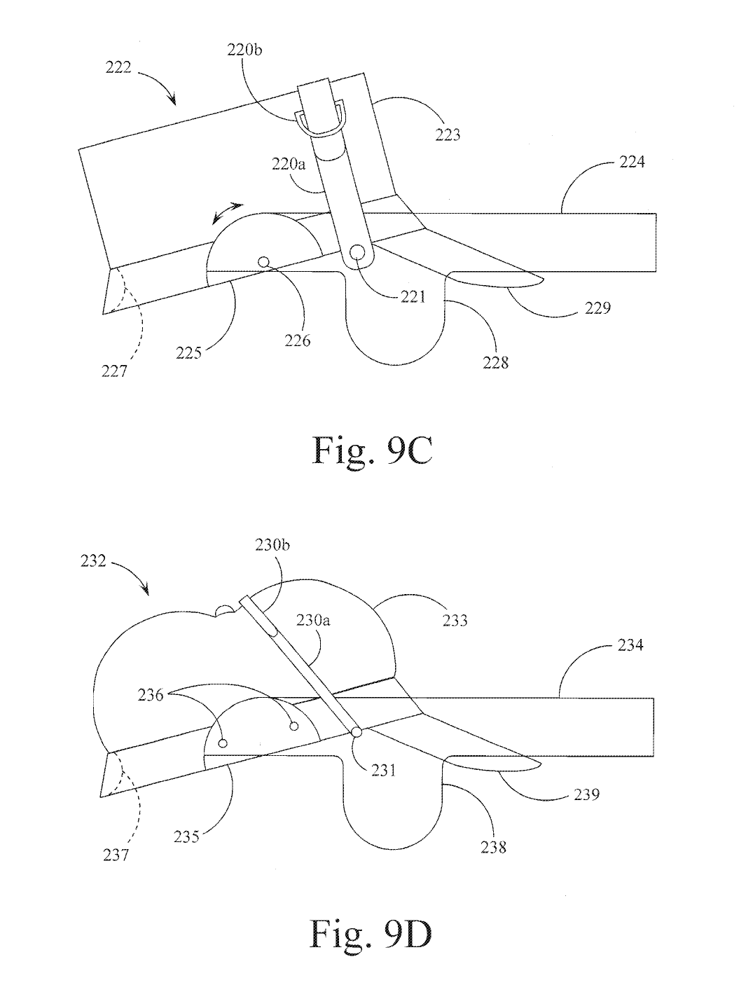

Reference is next made to FIGS. 9A-9D which are side elevational views of an alternate halo band structure implemented on (incorporated into) a variety of headbands, visors, hats, and caps. FIGS. 9A-9D represent a distinct method of attachment (or more specifically, incorporation) that allows for the use of the rearview mirror system of the present invention in conjunction with a variety of other non-helmet types of headgear. FIG. 9A represents the halo band accessory system 202 implemented on a headband component 203. The system 202 may be secured on the wearer with adjustable attachment component 207. Attachment component 207 may comprise hook and loop elements, cloth strap material, or button attachment sections. Flexible halo band 204 in this case incorporates eye glare guard section 208 that extends downward from flexible halo band 204 in the area adjacent the user's eyes. The eye glare guard section 208 provides for improved viewing the mirror component (not shown) that would be positioned forward from eye glare guard section 208.

The attachment of flexible halo band 204 to headband component 203 may preferably be made at bracket 205 positioned on headband 203. Bracket 205 may preferably incorporate a pivot point connection 206 that allows for some variation in the angle of flexible halo band 204 in front of the eyes of the user.

FIG. 9B represents the halo band accessory system 212 implemented on a visor component 213. The system 212 may be secured on the wearer with adjustable attachment component 217. Flexible halo band 214 in this case incorporates eye glare guard section 218 that extends downward from flexible band 214 in the area adjacent the user's eyes. Attachment of flexible halo band 214 to visor component 213 may preferably be made at bracket 215 positioned on visor 213. Bracket 215 may preferably incorporate a pivot point connection 216 that allows for some variation in the angle of flexible halo band 214 in front of the eyes of the user above or below front brim 219 of the visor 213.

FIG. 9C represents the halo band accessory system 222 implemented on a hat component 223 provided with adjustable attachment component 227. Flexible halo band 224 again incorporates eye glare guard section 228 that extends downward from flexible halo band 224 in the area adjacent the user's eyes. Attachment of the flexible halo band 224 to hat component 223 may be made at bracket 225 positioned as shown. Bracket 225 may preferably incorporate a pivot point connection 226 that allows for some variation in the angle of flexible halo band 224 in front of the eyes of the user, again above or below front brim 229 of hat 223. Additional support for halo band 224 is provided in this example by adjusting straps 220a and 220b that extend from an attachment point 221 on halo band 224 over hay component 223, to a second attachment point (not shown) on an opposite side of halo band 224.

FIG. 9D represents the halo band accessory system 232 implemented on a cap 233 provided with adjustable attachment component 237. Flexible halo band 234 again incorporates eye glare guard section 238 that extends downward from flexible halo band 234 in the area adjacent the user's eyes. Attachment of flexible halo band 234 to cap 233 may be made at bracket 235 positioned as shown. Bracket 235 in this case may preferably incorporate a non-pivoting connection 236 that more rigidly supports halo band 234 in a fixed position on cap 233. Additional support for halo band 234 is provided in this example by adjustable straps 230a and 230b that extend from an attachment point 231 on halo band 234, over cap 233, to a second attachment point (not shown) on an opposite side of halo band 234.

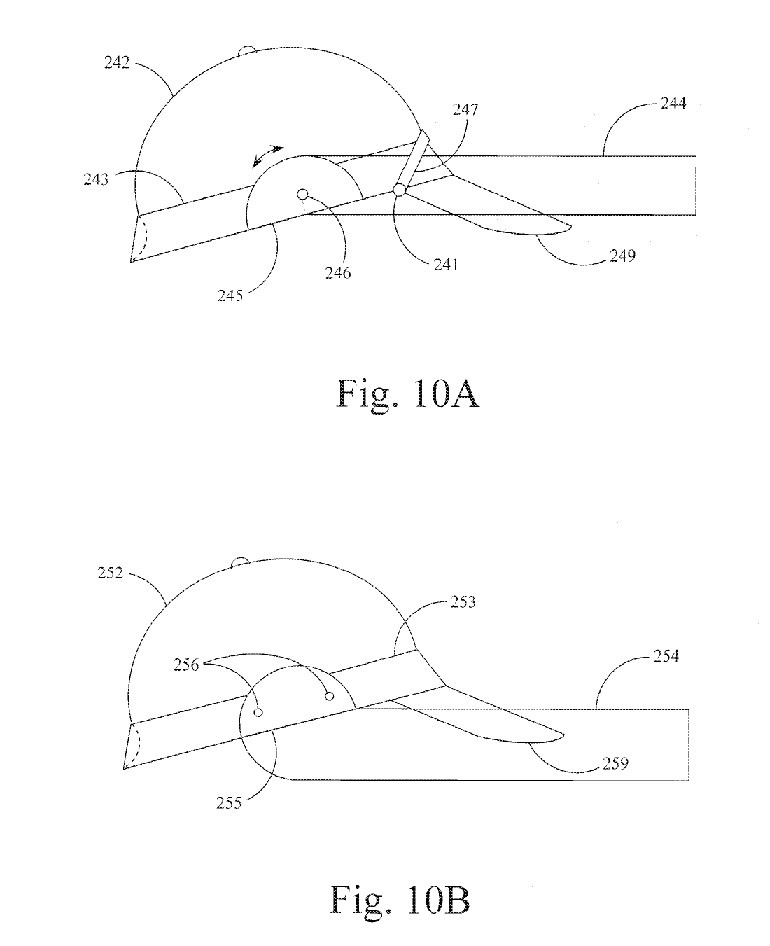

Reference is finally made to FIGS. 10A and 10B for a description of further alternate embodiments of the halo band component of the system of the present invention. In FIG. 10A, a straightforward and simple flexible halo band 244 is shown attached to a cap 242 similar to the manner in which the alternate embodiment shown in FIG. 9D is attached to the cap structured therein. In this case, a simple narrow flexible halo band 244 is attached to cap 242 at bracket 245 positioned on cap 242. Bracket 245 may again preferably incorporate a pivot point connection 246 that allows for variation in the angle of flexible halo band 244 in front of the eyes of the user above or below cap brim 249. Additional support for halo band 244 is provided in this example by strap 247 that extends from attachment point 241 on halo band 244.

FIG. 10B provides a wider flexible halo band 254 configuration, one in which the material from which flexible band 254 is constructed might better serve to provide shading to the eyes of the user fully across the user's front field of view. In a manner similar to that shown in FIG. 9D, attachment of flexible band 254 to cap 252 may be made at bracket 255 positioned on cap 252. Bracket 255 may again preferably incorporate a non-pivoting connection 256 that more rigidly supports halo band 254 in a fixed position around cap brim 259. Further variations on the geometric shape of the flexible band component of the system of the present invention are anticipated.

Although the present invention has been described in conjunction with the above preferred embodiments, those skilled in the art will recognize structural modifications and alternate construction materials that will likewise fall within the spirit and scope of the present invention. The geometric dimensions described are variable according to both the environment within which the system is used, and the overall size of the helmet to which the accessory system is attached. Variations in these geometries will be apparent to those skilled in the art according to these variations in the environment and size of the helmet.

In addition, the preferred materials from which the various components of the present invention may be constructed have been identified in the preferred embodiment so as to optimize the versatility of the system while at the same time minimizing cost and maximizing durability. Variations on the materials identified may be made to further minimize cost or to further improve durability.

I claim:

1. A system for retaining and adjustably positioning a rearview mirror safety accessory on a headgear component, the headgear component having a shell with left and right sides, a front, and a perimeter, the system comprising:
(a) a flexible, resilient halo band having a width and a length, the halo band further having first and second end sections;
(b) attachment means positioned on the first and second end sections of the halo band for attachment to the left and right sides of the shell of the headgear component; and
(c) a rearview mirror component slidingly positioned on the halo band and oriented to provide an individual wearing the headgear component with a rearward view.

2. The system of claim 1 wherein the rearview mirror component comprises a generally rectangular, semi-rigid panel, the panel further comprising:
(i) an attachment section defining a plurality of parallel slots, each of the slots having a length greater than the width of the halo band, the halo band receivable through the slots to position the rearview mirror component on the halo band; and
(ii) a reflective section, bendably connected to and extending from the attachment section, the reflective section comprising at least one optically reflective surface.

3. The system of claim 2 wherein the reflective section of the rearview mirror component further comprises a drop angle portion positioned and oriented to increase the field of view provided by the rearview mirror component.

4. The system of claim 2 wherein the rearview mirror component further comprises a panel of polymer plastic material, and the reflective section comprises a layer of reflective material adhered to at least a portion of the panel of polymer plastic material.

5. The system of claim 1 wherein the halo band comprises a clear polymer plastic material configured as a long, generally rectangular strap, which, when attached to the shell of the headgear component, extends radially around across the top of the field of vision of the wearer of the headgear component.

6. The system of claim 1 wherein the attachment means comprises a plurality of hook and loop fastener pads positioned between the first and second end sections of the halo band and at two points on the shell of the headgear component within field of vision.

7. The system of claim 1 wherein the attachment means comprises at least posts fixed on the headgear component, the posts operable to be inserted into and retained by apertures configured through the first and second end sections of the halo band.

8. The system of claim 2 wherein the length of each of the plurality of slots defined in the attachment section of the rearview mirror component is generally greater than the width of the halo band, the rearview mirror component thereby capable of being adjustably oriented at an angle with respect to the length of the halo band, whereby orientation of the rearview mirror component in a downward angle from a generally horizontal orientation of the halo band increases the portion of the reflective section of the rearview mirror component visible to the wearer of the headgear component.

9. The system of claim 2 wherein the reflective section of the rearview mirror component extends to the left from the attachment section in the field of view of the wearer of the headgear component when the rearview mirror component is positioned on the halo band and the halo band is positioned on the shell of the headgear component.

10. The system of claim 2 wherein the reflective section of the rearview mirror component extends to the right in the field of view of the wearer of the headgear component when the rearview mirror component is positioned on the halo band and the halo band is positioned on the shell of the headgear component.

11. The system of claim 1 wherein the headgear component comprises a bicycle helmet.

12. The system of claim 1 wherein the headgear component comprises a motorcycle helmet.

13. The system of claim 1 wherein the headgear component comprises a construction hardhat.

14. The system of claim 1 further comprising a second rearview mirror component slidingly positioned on the halo band and oriented on a side of the halo band opposite that of the first rearview mirror component.

15. The system of claim 1 wherein the halo band comprises a shaded, partially transparent polymer plastic material configured as a long, generally rectangular strap, which, when attached to the shell of the headgear component, extends radially around across the top of the field of vision of the wearer of the headgear component.

16. The system of claim 1 further comprising an adjustable support strap extending from a first attachment point on the halo band on a first side of the headgear component to a second attachment point on an opposing side of the headgear component.

17. The system of claim 1 wherein the halo band further comprises first and second eye glare guard extensions, the eye glare guard extensions positioned on the halo band such that when the halo band is attached to the headgear component the eye glare guards serve to shield the user's eyes from the side.

18. The system of claim 1 wherein the attachment means comprise pivoting attachment means allowing the halo band and the rearview mirror component to pivot up and out of the user's field of view.

19. A system for retaining and adjustably positioning a rearview mirror safety accessory on a headgear component, the headgear component having a shell with left and right sides, a front, and a perimeter, the system comprising:
(a) a flexible, resilient halo band having a width and a length, the halo band further having first and second end sections, the halo band further comprising a clear polymer plastic material configured as a long, generally rectangular strap, which, when attached to the shell of the headgear component, extends radially around the front of the shell across the field of vision of the wearer of the headgear component;
(b) attachment means positioned on the first and second end sections of the halo band for attachment to the left and right sides of the shell of the headgear component; and
(c) a rearview mirror component slidingly positioned on the halo band and oriented to provide an individual wearing the headgear component with a rearward view, the rearview mirror component comprising a generally rectangular, semi-rigid panel, comprising polymer plastic material, the panel further comprising:
(i) an attachment section defining a plurality of parallel slots, each of the slots having a length greater than the width of the halo band, the halo band receivable through the slots to position the rearview mirror component on the halo band; and
(ii) a reflective section, bendably connected to and extending from the attachment section, the reflective section comprising at least one optically reflective surface comprising a layer of reflective material adhered to at least a portion of the panel of polymer plastic material, the reflective section further comprising a drop angle portion positioned and oriented to increase the field of view provided by the rearview mirror component;
wherein the rearview mirror component may be variably oriented by the wearer of the headgear component to provide a view behind and to the side of the wearer when the rearview mirror component is positioned on the halo band and the halo band is positioned on the shell of the headgear component.
